(19) United States
(12) Patent Application Publication
(10) Pub. No.: US 2016/0119643 A1
(43) Pub. Date: Apr. 28, 2016

(54) Method and Apparatus for Advanced Temporal Residual Prediction in Three-Dimensional Video Coding

(71) Applicant: MEDIA TEK SINGAPORE PTE. LTD., Singapore (SG)

(72) Inventors: Jicheng AN, Beijing City (CN); Kai ZHANG, Beijing (CN); Jian-Liang LIN, Su'ao Township, Yilan County (TW)

(21) Appl. No.: 14/891,114

(22) PCT Filed: Jul. 10, 2014
(86) PCT No.: PCT/CN2014/081951

§ 371 Date: Nov. 13, 2015

(30) Foreign Application Priority Data
Jul. 16, 2013 (CN) PCT/CN2013/079468
Nov. 14, 2013 (CN) PCT/CN2013/087117

(51) Int. Cl. H04N 19/597; H04N 19/139; H04N 13/00; H04N 19/172; H04N 19/176; H04N 19/105; H04N 19/513

(52) U.S. Cl. CPC H04N 19/597; H04N 19/105; H04N 19/139; H04N 19/513; H04N 19/172; H04N 19/176; H04N 13/0048

(57) ABSTRACT

A method and apparatus for three-dimensional or multi-view video coding using advanced temporal residual prediction are disclosed. The method determines a corresponding block in a temporal reference picture in the current dependent view for the current block. The reference residual for the corresponding block is determined according to the current motion or disparity parameters. Predictive encoding or decoding is then applied to the current block based on the reference residual. When the current block is coded using DCP (disparity compensated prediction), the reference residual is used as a predictor for the current residual generated by applying the DCP to the current block. The current block may correspond to a PU (prediction unit) or a CU (coding unit).

### CROSS REFERENCE TO RELATED APPLICATIONS

The present invention is a National Phase Application of PCT Application No. PCT/2014/081951, filed on Jul. 10, 2014, which claims priority to PCT Patent Application, Serial No. PCT/CN2013/079468, filed on Jul. 16, 2013, entitled “Methods for Residual Prediction” and PCT Patent Application, Serial No. PCT/CN2013/087117, filed on Nov. 14, 2013, entitled “Method and Apparatus for Residual Prediction in Three-Dimensional Video Coding”. The PCT Patent Applications are hereby incorporated by reference in their entireties.

### FIELD OF INVENTION

The present invention relates to three-dimensional and multi-dimensional video coding. In particular, the present invention relates to video coding using temporal residual prediction.

### BACKGROUND OF THE INVENTION

Three-dimensional (3D) television has been a technology trend in recent years that intends to bring viewers sensational viewing experience. Various technologies have been developed to enable 3D viewing. The multi-view video is a key technology for 3DTV application among others. The traditional video is a two-dimensional (2D) medium that only provides viewers a single view of a scene from the perspective of the camera. However, the multi-view video is capable of offering arbitrary viewpoints of dynamic scenes and provides viewers the sensation of realism. 3D video formats may also include depth maps associated with corresponding texture pictures. The depth maps also have to be coded to rendering three-dimensional view or multi-view.

Various techniques to improve the coding efficiency of 3D video coding have been disclosed in the field. There are also activities to standardize the coding techniques. For example, a working group, ISO/IEC JTC1/SC29/WG11 within ISO (International Organization for Standardization) is developing an HEVC (High Efficiency Video Coding) based 3D video coding standard (named 3D-HEVC). To reduce the inter-view redundancy, a technique, called disparity-compensated prediction (DCP) has been added as an alternative coding tool to motion-compensated prediction (MCP). MCP is also referred as Inter picture prediction that uses previously coded pictures of the same view in a different access unit (AU), while DCP refers to an Inter picture prediction that uses already coded pictures of other views in the same access unit.

For 3D-HEVC, an advanced residual prediction (ARP) method has been disclosed to improve the efficiency of IVRP (inter-view residual prediction), where the motion of a current view is applied to the corresponding block in a reference view. Furthermore, an additional weighting factor is introduced to compensate the quality difference between different views. FIG. 1 illustrates an exemplary structure of advanced residual prediction (ARP) as disclosed in 3D-HEVC, where the temporal (i.e., inter-time) residual (190) for a current block (112) is predicted using reference temporal residual (170) to form new residual (180). Residual 190 correspond to the temporal residual signal between the current block (110) and a temporal reference block (150) in the same view. View 0 denotes the base view and view 1 denotes the dependent view. The procedure is described as follows.
1. An estimated DV (120) for the current block (110) referring to an inter-view reference is derived. This inter-view reference denoted as corresponding picture (CP) is in the base view and has the same POC as that of the current picture in view 1. A corresponding region 130 in the corresponding picture for the current block (110) in the current picture is located according to the estimated DV (120). The reconstructed pixel of the corresponding region (130) is denoted as S.
2. Reference corresponding picture in the base view with the same POC as that of the reference picture for the current block (110) is found. The MV (160) of the current block is used for the corresponding region (130) to locate reference corresponding region 140 in the reference corresponding picture, whose relative displacement towards the current block is DV+MV. The reconstructed image in the reference corresponding picture is noted as Q.
3. The reference residual (170) is calculated as RR=S−Q. The operation here is sample-wised, i.e., RR[j,i]=S[j,i]−Q[j,i], where RR[j,i] is a sample in reference residual, S[j,i] is a sample in the corresponding region (130), Q[j,i] is a sample in the reference corresponding region (140), and [j,i] is a relative position in the region. In the following descriptions, operations on a region are all sample-wise operations.
4. The reference residual (170) will be used as the residual prediction for the current block to generate final residual (180). Furthermore, a weighting factor can be applied to the reference residual to obtain a weighted residual for prediction. For example, three weighting factors can be used in ARP, i.e., 0, 0.5 and 1, where 0 implies no ARP is used.

The ARP process is only applicable to blocks that use motion compensated prediction (MCP). For blocks that use disparity compensated prediction (DCP), the ARP is not applied. It is desirable to develop residual prediction technique that is also applicable to DCP-coded blocks.

### SUMMARY OF THE INVENTION

A method and apparatus for three-dimensional or multi-view video coding using advanced temporal residual prediction are disclosed. The method determines a corresponding block in a temporal reference picture in the current dependent view for the current block. The reference residual for the corresponding block is determined according to the current motion or disparity parameters. Predictive encoding or decoding is then applied to the current block based on the reference residual. When the current block is coded using DCP (disparity compensated prediction), the reference residual is used as a predictor for the current residual generated by applying the DCP to the current block. The current block may correspond to a PU (prediction unit) or a CU (coding unit).

The corresponding block in the temporal reference picture can be located based on the current block using a DMV (derived motion vector) and the DMV corresponds to a selected MV (motion vector) of a selected reference block in a reference view. The selected reference block can be located from the current block using a MV, a DV (disparity vector), or a DDV (derived DV) of the current block. The DDV can also be derived according to ADVD (adaptive disparity vector derivation), and the ADVD is derived based on one or more temporal neighboring blocks and two spatial neighboring blocks. The two spatial neighboring blocks are located at an above-right position and a left-bottom position of the current block. Temporal neighboring blocks may correspond to one aligned temporal reference block and one collocated temporal reference block of the current block, and the aligned temporal reference block is located in the temporal reference picture from the current block using a scaled MV. A default DV can be used if either a temporal neighboring block or a spatial neighboring block is not available. The ADVD technique can also be applied to the conventional ARP to determine the corresponding block in an inter-view reference picture in a reference view for the current block.

The DMV can be scaled to a first temporal reference picture based on the reference index of the reference list or a selected reference picture in the reference list. The first temporal reference picture or the selected reference picture is then used as the temporal reference picture in the current dependent view for the current block. The DMV can be set to a motion vector of a spatial neighboring block or a temporal neighboring block of the current block. The DMV can be signaled explicitly in a bitstream. When the DMV is zero, the corresponding block in the temporal reference picture corresponds to a collocated bock of the current block.

A flag can be signaled for each block to control On, Off or weighting factor related to the predictive encoding or decoding of the current block based on the reference residual. The flag can be explicitly signaled in a sequence level, view level, picture level or slice level. The flag may also be inherited in a Merge mode. The weighting factor may correspond to ½.

### BRIEF DESCRIPTION OF THE DRAWINGS

FIG. 1 illustrates an exemplary structure of advanced residual prediction, where the current inter-time residual is predicted in the view direction using reference inter-time residual according to 3D-HEVC.

FIG. 2 illustrates a simplified diagram of advanced temporal residual prediction according to an embodiment of the present invention, where the current inter-view residual is predicted in the temporal direction using reference inter-view residual.

FIG. 3 illustrates an exemplary structure of advanced temporal residual prediction according to an embodiment of the present invention, where the current inter-view residual is predicted in the temporal direction using reference inter-view residual.

FIG. 4 illustrates an exemplary process for determining derived motion vector to locate a temporal reference block of the current block.

FIG. 5 illustrates the two spatial neighboring blocks used to derive disparity vector candidate or motion vector candidate for adaptive disparity vector derivation (ADVD).

FIG. 6 illustrates an aligned temporal disparity vector and a temporal disparity vector for aligned temporal DV (ATDV).

FIG. 7 illustrates an exemplary flowchart of advanced temporal residual prediction according to an embodiment of the present invention.

FIG. 8 illustrates an exemplary flowchart of advanced residual prediction using ADVD (adaptive disparity vector derivation) to determine a corresponding block in an inter-view reference picture in a reference view according to an embodiment of the present invention.

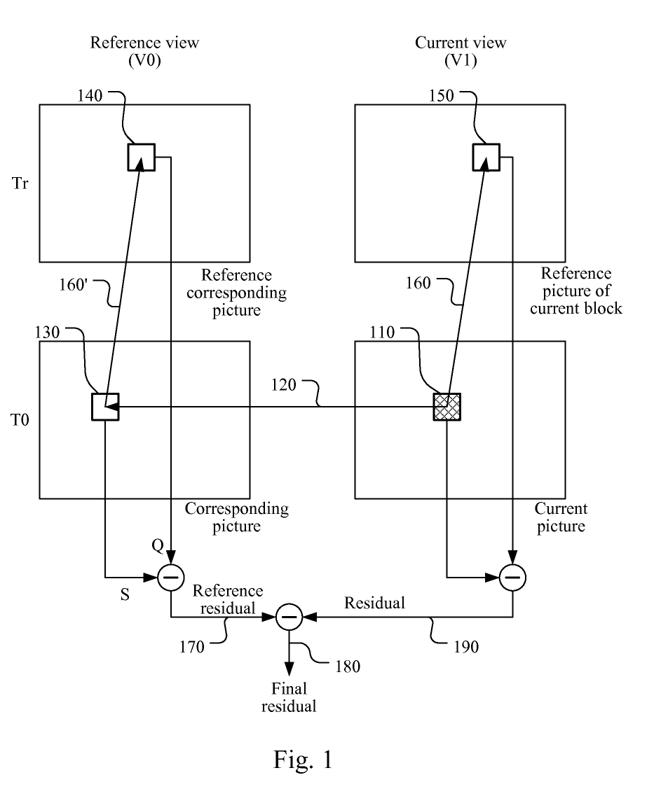

### DETAILED DESCRIPTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

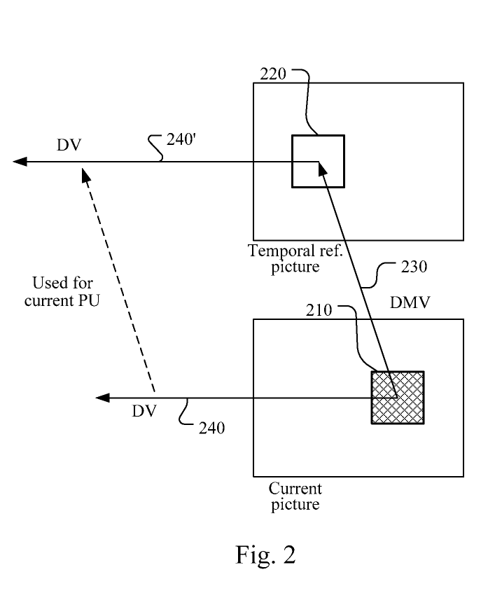

In order to improve the performance of a 3D coding system, the present invention discloses an advanced temporal residual prediction (ATRP) technique. In ATRP, at least a portion of the motion or disparity parameters of the current block (e.g., a prediction unit (PU) or a coding unit (CU)) is applied to the corresponding block in a temporal reference picture in the same view to generate the reference residual in the temporal direction. The corresponding block in the temporal reference picture is located by a derived motion vector (DMV). For example, the DMV may be the motion vector (MV) of the reference block that is pointed by the current DV in the reference view. A simplified exemplary ATRP process is illustrated in FIG. 2.

In FIG. 2, a current block (210) in the current picture is a DCP (disparity compensated prediction) coded block having a disparity vector (240). A derived motion vector (DMV, 230) is used to locate a temporal reference block (220) in a temporal reference picture, where the current picture and the temporal reference picture are in the same reference view. The disparity vector (240) of the current block is used as the disparity vector (240′) of the temporal reference block. By using the disparity vector (240′), inter-view residual for the temporal reference block (220) can be derived. The inter-view residual of the current block (210) can be predicted from a temporal direction by the inter-view residual. While the disparity vector (DV) of the current block (210) is used by the temporal reference block (220) of the current block to derive the inter-view residual for the temporal reference block (220), other motion information (e.g., motion vector (MV) or derived DV) may also be used to derive the inter-view residual for the temporal reference block (220).

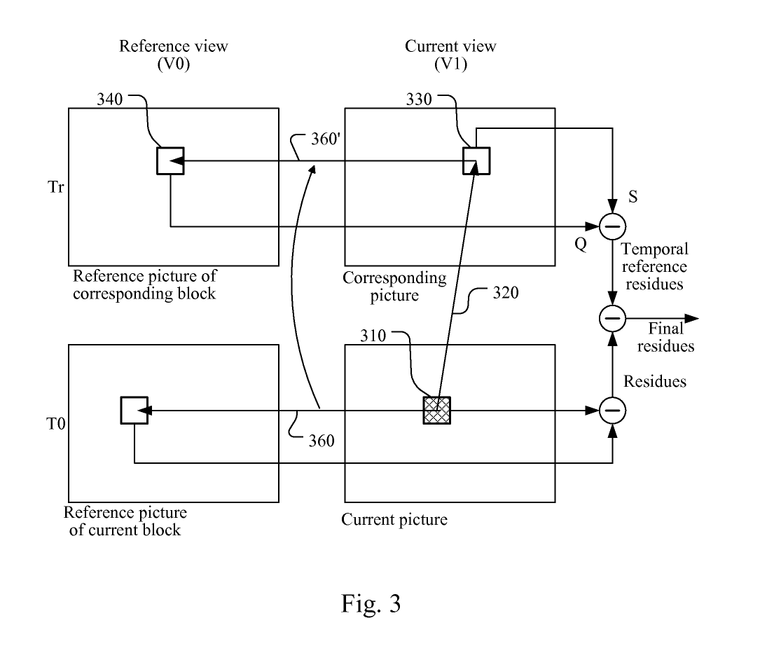

FIG. 3 illustrates an example of ATRP structure. View 0 denotes a reference view such as the base view and view 1 denotes the dependent view. A current block (312) in a current picture (310) in view 1 is being coded. The procedure is described as follows.
1. An estimated MV (320) for the current block (310) referring to an inter-time (i.e., temporal) reference is derived. This inter-time reference denoted as corresponding picture is in view 1. A corresponding region (330) in the corresponding picture is located for the current block using the estimated MV. The reconstructed samples of the corresponding region (330) is noted as S. The corresponding region may have the same image unit structure (e.g., Macroblock (MB), Prediction Unit (PU), Coding Unit (CU) or Transform Unit (TU)) as the current block. Nevertheless, the corresponding region may also have different image unit structure from the current block. The corresponding region may also be larger or smaller than the current block. For example, the current block corresponds to a CU and the corresponding block corresponds to PU.
2. The inter-view reference picture in the reference view for the corresponding region, which has the same POC as that of the corresponding picture in view 1 is found. The same DV (360′) as that of the current block is used on corresponding region (330) to locate an inter-view reference block 340 (denoted as Q) in the inter-view reference picture in the reference view for the corresponding block (330), the relative displacement between the reference block (340) towards the current block (310) is MV+DV. The reference residual in the temporal direction are derived as (S−Q).
3. The reference residual in the temporal direction will be used for encoding or decoding of the residual of the current block to form the final residual. Similar to the ARP, a weighting factor can be used for ATRP. For example, the weighting factor may correspond to 0, ½ and 1, where 0/1 imply the ATRP is Off/On.

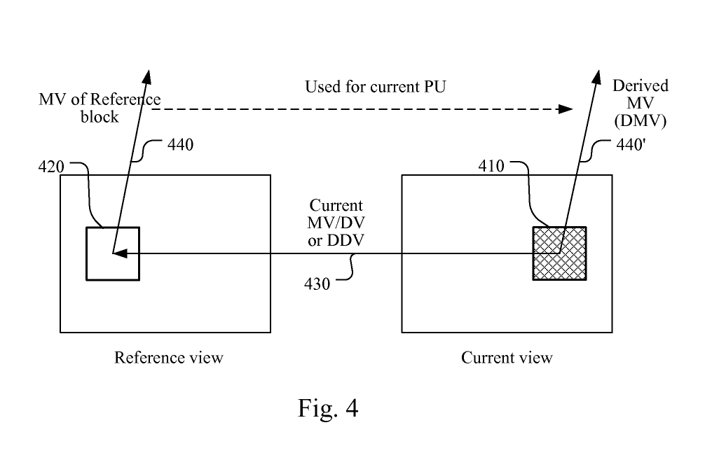

An example of derivation of the DMV is illustrated in FIG. 4. The current MV/DV or derived DV (430) is used to locate a reference block (420) in the reference view corresponding to the current block (410) in the current view. The MV (440) of the reference block (420) can be used as the derived MV (440′) for the current block (410). An exemplary procedure to derive the DMV is shown as follows (referred as DMV derivation procedure 1).

Add the current MV/DV in list X (X=0 or 1) or DDV (derived DV) to the middle position (or other positions) of the current block (e.g., PU or CU) to obtain a sample position, and find the reference block which covers the sample location in the reference view.

If the reference picture in list X of the reference block has the same POC (picture order count) as one reference picture in current reference list X,
Set DMV to the MV in list X of the reference block;
   Else,
If the reference picture in list 1-X of the reference block has the same POC as one reference picture in current reference list X,
   Set DMV to the MV in list 1-X of the reference block;
Else,
   Set DMV to a default value such as (0, 0) pointing to the temporal reference picture in list X with the smallest reference index.

Alternatively, the DMV can also be derived as follows (referred as DMV derivation procedure 2).

Add the current MV/DV in list X or DDV to the middle position of current PU to obtain a sample position, and find the reference block which covers that sample location in the reference view.

If the reference picture in list X of the reference block has the same POC as one reference picture in current reference list X,

1 Set DMV to the MV in list X of the reference block;
Else,
Set DMV to a default value such as (0, 0) pointing to the temporal reference picture in list X with the smallest reference index.

In the above two examples of DMV derivation procedure, the DMV can be scaled to the first temporal reference picture (in terms of reference index) in the reference list X if the DMV points to another reference picture. Any MV scaling technique known in the field can be used. For example, the MV scaling can be based on the POC (picture order count) distance.

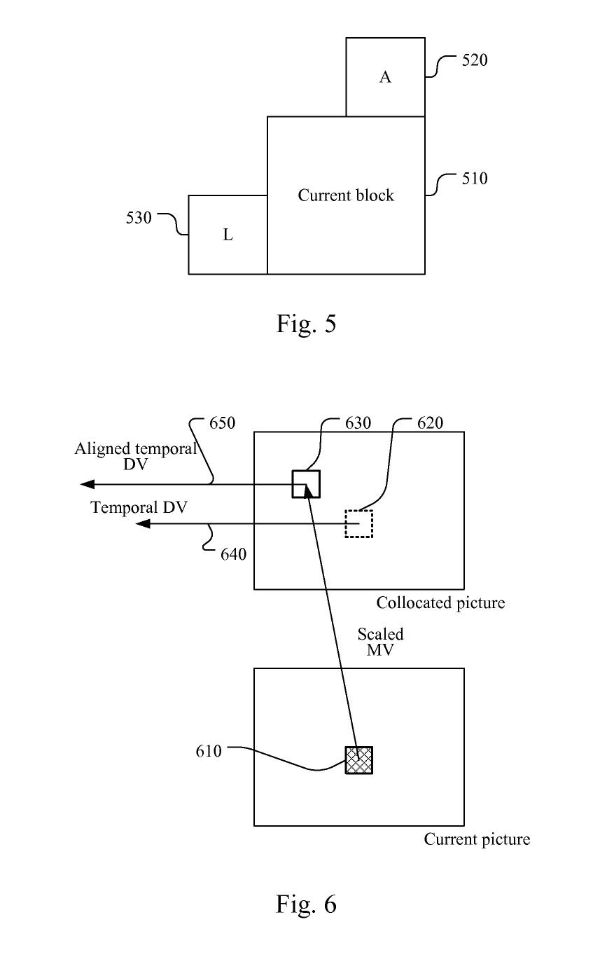

In another embodiment, an adaptive disparity vector derivation (ADVD) is disclosed in order to improve the ARP coding efficiency. In ADVD, three DV candidates are derived from temporal/spatial neighbouring blocks. Only two spatial neighbors (520 and 530) of the current block (510) are checked as depicted in FIG. 5. A new DV candidate is inserted into the list only if it is not equal to any DV candidate already in the list. If the DV candidate list is not fully populated after exploiting neighbouring blocks, default DVs will be added. An encoder can determine the best DV candidate used in ARP according to RDO criterion, and signal the index of the selected DV candidate to the decoder.

For further improvement, aligned temporal DV (ATDV) is disclosed as an additional DV candidate. ATDV is obtained from the aligned block, which is located by a scaled MV to the collocated picture, as shown in FIG. 6. Two collocated pictures are utilized, which can also be used in the NBDV derivation. ATDV is checked before DV candidates from neighbouring blocks when it is used.

The ADVD technique can be applied to ATRP to find a derived MV. In one example, three MV candidates are derived for ATRP similar to the three DV candidates derived for ARP in ADVD. DMV is placed into the MV candidate list if the DMV exists. Then spatial/temporal neighbouring blocks are checked to find more MV candidates similar to the process of finding a merging candidate. Also, only two spatial neighbors are checked as depicted in FIG. 5. If the MV candidate list is not fully populated after exploiting neighboring blocks, default MVs will be added. An encoder can find the best MV candidate used in ATRP according to RDO criterion, and signal the index to the decoder, similar to what is done in ADVD for ARP.

A system incorporating new advanced residual prediction (ARP) according to embodiments of the present invention is compared with a conventional system (3D-HEVC Test Model version 8.0 (HTM 8.0)) with conventional ARP. The system configurations according to embodiments of the present invention are summarized in Table 1. The conventional system has ADVD, ATDV and ATRP all set to Off. The results for Test 1 through Test 5 are listed in Table 2 through Table 6 respectively.

TABLE 1

| | ADVD | ATDV | ½ weighting | ATRP |
|---|---|---|---|---|
| Test 1 | On | Off | On | Off |
| Test 2 | On | Off | Off | Off |
| Test 3 | Off | Off | On | On |
| Test 4 | On | On | Off | Off |
| Test 5 | On | On | Off | On |

The performance comparison is based on different sets of test data listed in the first column. The BD-rate differences are shown for texture pictures in view 1 (video 1) and view 2 (video 2). A negative value in the BD-rate implies that the present invention has a better performance. As shown in Tables 2-6, the system incorporating embodiments of the present invention shows noticeable BD-rate reduction from 0.6% to 2.0% for view 1 and view 2. The BD-rate measure for the coded video PSNR with video bitrate, the coded video PSNR with total bitrate (texture bitrate and depth bitrate), and the synthesized video PSNR with total bitrate also show noticeable BD-rate reduction (0.2%-0.8%). The encoding time, decoding time and rendering time are just slightly higher than the conventional system. However, the encoding time for Test 1 increases by 10.1%.

TABLE 2

| | | | | Video | Video | Synth | | | |
|---|---|---|---|---|---|---|---|---|---|
| | | | | PSNR/ | PSNR/ | PSNR/ | | | |
| | | | | video | total | total | Enc | Dec | Ren |
| | Video 0 | Video 1 | Video 2 | bitrate | bitrate | bitrate | time | time | time |
| Balloons | 0.0% | −1.3% | −1.4% | −0.6% | −0.5% | −0.4% | 112.2% | 104.8% | 100.8% |
| Kendo | 0.0% | −2.2% | −2.1% | −0.9% | −0.8% | −0.6% | 110.7% | 93.4% | 99.9% |
| Newspapercc | 0.0% | −1.1% | −0.7% | −0.4% | −0.4% | −0.3% | 109.5% | 98.1% | 101.7% |
| GhostTownFly | 0.0% | 0.0% | 0.0% | −0.1% | 0.0% | 0.0% | 106.4% | 100.4% | 101.2% |
| PoznanHall2 | 0.0% | −0.9% | −0.6% | −0.3% | −0.3% | −0.3% | 109.6% | 109.7% | 104.7% |
| PoznanStreet | 0.0% | −0.7% | −0.9% | −0.3% | −0.3% | −0.2% | 109.2% | 96.6% | 104.5% |
| UndoDancer | 0.0% | −0.6% | −0.7% | −0.2% | −0.2% | −0.2% | 112.8% | 103.7% | 100.6% |
| 1024x768 | 0.0% | −1.5% | −1.4% | −0.6% | −0.6% | −0.4% | 110.8% | 98.8% | 100.8% |
| 1920x1088 | 0.0% | −0.5% | −0.5% | −0.2% | −0.2% | −0.2% | 109.5% | 102.6% | 102.7% |
| average | 0.0% | −1.0% | −0.9% | −0.4% | −0.4% | −0.3% | 110.1% | 101.0% | 101.9% |

TABLE 3

| | | | | Video | Video | Synth | | | |
|---|---|---|---|---|---|---|---|---|---|
| | | | | PSNR/ | PSNR/ | PSNR/ | | | |
| | | | | video | total | total | Enc | Dec | Ren |
| | Video 0 | Video 1 | Video 2 | bitrate | bitrate | bitrate | time | time | time |
| Balloons | 0.0% | −1.9% | −2.1% | −0.8% | −0.7% | −0.6% | 102.8% | 101.6% | 99.4% |
| Kendo | 0.0% | −2.5% | −2.4% | −0.9% | −0.8% | −0.7% | 102.5% | 103.1% | 99.7% |
| Newspapercc | 0.0% | −1.3% | −1.0% | −0.5% | −0.4% | −0.3% | 103.1% | 103.4% | 99.0% |
| GhostTownFly | 0.0% | −0.2% | −0.2% | −0.1% | −0.1% | −0.1% | 100.8% | 91.8% | 99.1% |
| PoznanHall2 | 0.0% | −0.8% | −1.0% | −0.4% | −0.3% | −0.4% | 104.3% | 100.9% | 112.6% |
| PoznanStreet | 0.0% | −1.0% | −1.1% | −0.3% | −0.3% | −0.3% | 102.4% | 101.8% | 98.9% |
| UndoDancer | 0.0% | −0.9% | −0.9% | −0.3% | −0.2% | −0.2% | 103.8% | 95.8% | 101.0% |
| 1024x768 | 0.0% | −1.9% | −1.8% | −0.7% | −0.6% | −0.5% | 102.8% | 102.7% | 99.4% |
| 1920x1088 | 0.0% | −0.7% | −0.8% | −0.3% | −0.2% | −0.2% | 102.8% | 97.6% | 102.9% |
| average | 0.0% | −1.2% | −1.2% | −0.5% | −0.4% | −0.4% | 102.8% | 99.8% | 101.4% |

TABLE 4

| | | | | Video | Video | Synth | | | |
|---|---|---|---|---|---|---|---|---|---|
| | | | | PSNR/ | PSNR/ | PSNR/ | | | |
| | | | | video | total | total | Enc | Dec | Ren |
| | Video 0 | Video 1 | Video 2 | bitrate | bitrate | bitrate | time | time | time |
| Balloons | 0.0% | −1.0% | −0.8% | −0.4% | −0.3% | −0.3% | 100.2% | 107.9% | 98.1% |
| Kendo | 0.0% | −1.4% | −1.5% | −0.5% | −0.4% | −0.4% | 99.9% | 95.0% | 103.3% |
| Newspapercc | 0.0% | −0.8% | −0.3% | −0.2% | −0.1% | −0.1% | 100.5% | 103.0% | 98.8% |
| GhostTownFly | 0.0% | 0.1% | 0.0% | 0.0% | 0.0% | 0.0% | 100.5% | 100.2% | 105.9% |
| PoznanHall2 | 0.0% | 0.1% | 0.0% | 0.0% | 0.0% | −0.1% | 101.6% | 110.5% | 100.5% |
| PoznanStreet | 0.0% | −0.4% | −0.5% | −0.1% | −0.1% | −0.1% | 100.7% | 101.5% | 102.5% |
| UndoDancer | 0.0% | −0.6% | −0.7% | −0.2% | −0.2% | −0.2% | 100.7% | 94.7% | 100.1% |
| 1024x768 | 0.0% | −1.0% | −0.9% | −0.4% | −0.3% | −0.3% | 100.2% | 102.0% | 100.1% |
| 1920x1088 | 0.0% | −0.2% | −0.3% | −0.1% | −0.1% | −0.1% | 100.9% | 101.7% | 102.2% |
| average | 0.0% | −0.6% | −0.6% | −0.2% | −0.2% | −0.2% | 100.6% | 101.8% | 101.3% |

TABLE 5

| | | | | Video | Video | Synth | | | |
|---|---|---|---|---|---|---|---|---|---|
| | | | | PSNR/ | PSNR/ | PSNR/ | | | |
| | | | | video | total | total | Enc | Dec | Ren |
| | Video 0 | Video 1 | Video 2 | bitrate | bitrate | bitrate | time | time | time |
| Balloons | 0.0% | −2.7% | −2.8% | −1.1% | −1.0% | −0.9% | 102.3% | 108.8% | 102.4% |
| Kendo | 0.0% | −3.0% | −2.8% | −1.1% | −1.0% | −0.8% | 102.2% | 99.4% | 101.9% |
| Newspapercc | 0.0% | −1.7% | −1.3% | −0.6% | −0.5% | −0.4% | 103.3% | 95.7% | 98.8% |
| GhostTownFly | 0.0% | −0.1% | −0.2% | −0.1% | −0.1% | −0.1% | 101.0% | 103.4% | 100.2% |
| PoznanHall2 | 0.0% | −1.3% | −1.1% | −0.5% | −0.4% | −0.4% | 104.4% | 110.1% | 102.7% |
| PoznanStreet | 0.0% | −1.1% | −1.4% | −0.4% | −0.4% | −0.3% | 102.2% | 98.9% | 102.3% |
| UndoDancer | 0.0% | −0.9% | −0.9% | −0.3% | −0.2% | −0.2% | 103.3% | 96.3% | 104.2% |
| 1024x768 | 0.0% | −2.5% | −2.3% | −0.9% | −0.8% | −0.7% | 102.6% | 101.3% | 101.0% |
| 1920x1088 | 0.0% | −0.9% | −0.9% | −0.3% | −0.3% | −0.3% | 102.7% | 102.2% | 102.3% |
| average | 0.0% | −1.6% | −1.5% | −0.6% | −0.5% | −0.4% | 102.7% | 101.8% | 101.8% |

TABLE 6

| | | | | Video | Video | Synth | | | |
|---|---|---|---|---|---|---|---|---|---|
| | | | | PSNR/ | PSNR/ | PSNR/ | | | |
| | | | | video | total | total | Enc | Dec | Ren |
| | Video 0 | Video 1 | Video 2 | bitrate | bitrate | bitrate | time | time | time |
| Balloons | 0.0% | −3.3% | −3.3% | −1.3% | −1.2% | −1.1% | 103.0% | 109.7% | 101.3% |
| Kendo | 0.0% | −3.9% | −4.2% | −1.6% | −1.3% | −1.2% | 102.0% | 100.6% | 105.9% |
| Newspapercc | 0.0% | −2.1% | −1.7% | −0.8% | −0.7% | −0.5% | 103.0% | 103.6% | 98.8% |
| GhostTownFly | 0.0% | −0.2% | −0.3% | −0.2% | −0.1% | −0.1% | 101.7% | 100.3% | 102.1% |
| PoznanHall2 | 0.0% | −1.3% | −1.4% | −0.6% | −0.5% | −0.5% | 102.7% | 100.7% | 100.4% |
| PoznanStreet | 0.0% | −1.4% | −1.6% | −0.5% | −0.5% | −0.4% | 103.1% | 95.0% | 100.5% |
| UndoDancer | 0.0% | −1.2% | −1.4% | −0.4% | −0.3% | −0.3% | 104.8% | 100.7% | 101.5% |
| 1024x768 | 0.0% | −3.1% | −3.1% | −1.2% | −1.1% | −0.9% | 102.6% | 104.6% | 102.0% |
| 1920x1088 | 0.0% | −1.0% | −1.2% | −0.4% | −0.4% | −0.3% | 103.1% | 99.2% | 101.1% |
| average | 0.0% | −1.9% | −2.0% | −0.8% | −0.7% | −0.6% | 102.9% | 101.5% | 101.5% |

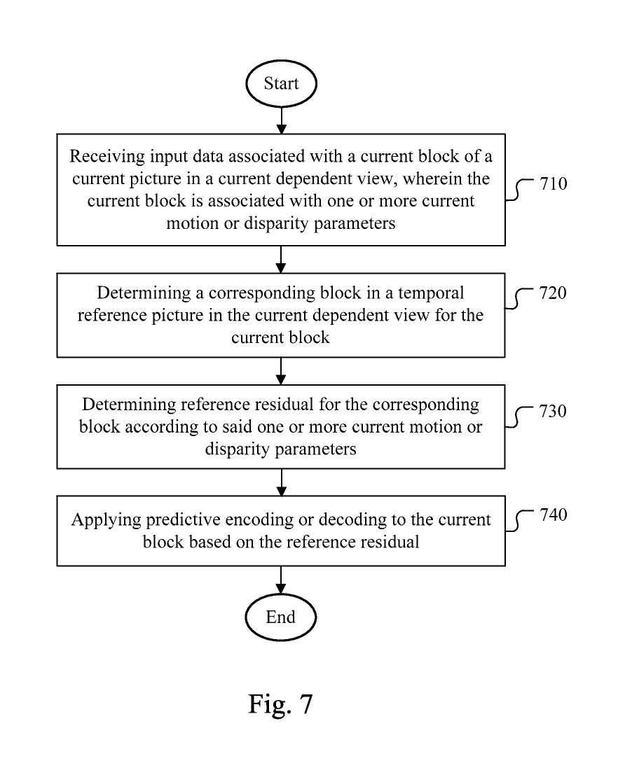

FIG. 7 illustrates an exemplary flowchart for a three-dimensional or multi-view video coding system using advanced temporal residual prediction (ATRP) according to an embodiment of the present invention. The system receives input data associated with a current block of a current picture in a current dependent view as shown in step 710, where the current block is associated with one or more current motion or disparity parameters. The input data may correspond to un-coded or coded texture data, depth data, or associated motion information. The input data may be retrieved from storage such as a computer memory, buffer (RAM or DRAM) or other media. The input data may also be received from a processor such as a controller, a central processing unit, a digital signal processor or electronic circuits that derives the input data. A corresponding block in a temporal reference picture in the current dependent view is determined for the current block as shown in step 720. Reference residual for the corresponding block is determined according to said one or more current motion or disparity parameters as shown in step 730. Predictive encoding or decoding is applied to the current block based on the reference residual as shown in step 740.

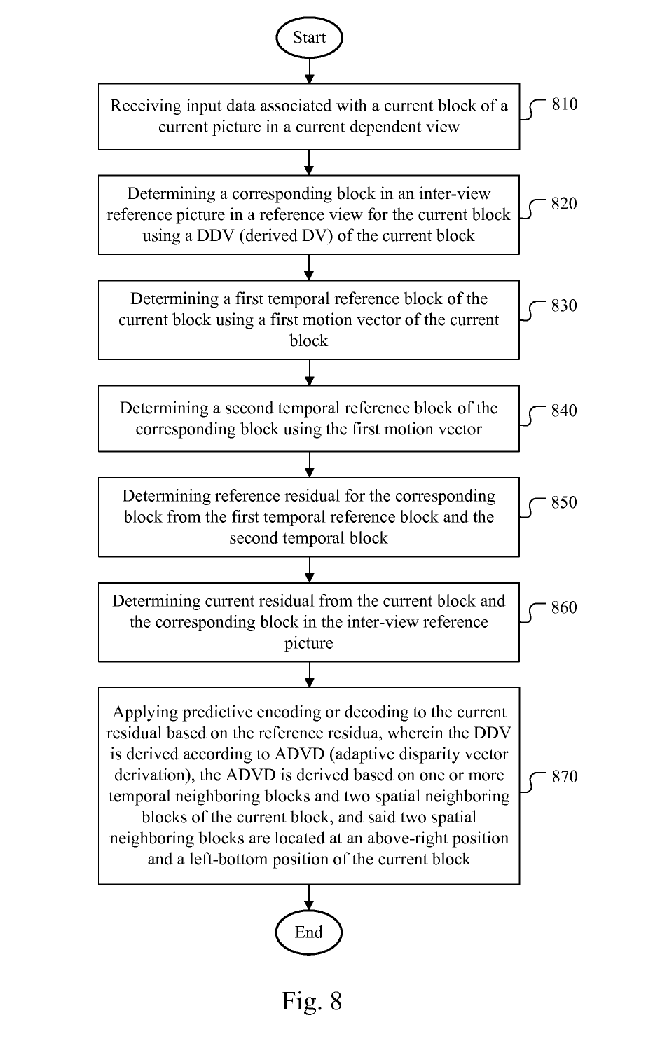

FIG. 8 illustrates an exemplary flowchart for a three-dimensional or multi-view video coding system using ADVD (adaptive disparity vector derivation) for advanced residual prediction (ARP) according to an embodiment of the present invention. The system receives input data associated with a current block of a current picture in a current dependent view as shown in step 810. A corresponding block in an inter-view reference picture in a reference view for the current block is determined using a DDV (derived DV) of the current block in step 820. A first temporal reference block of the current block is determined using a first motion vector of the current block in step 830. A second temporal reference block of the corresponding block is determined using the first motion vector in step 840. Reference residual for the corresponding block is determined from the first temporal reference block and the second temporal block in step 850. Current residual is determined from the current block and the corresponding block in the inter-view reference picture in step 860. Encoding or decoding is applied to the current residual based on the reference residual in step 870, wherein the DDV is derived according to ADVD (adaptive disparity vector derivation), the ADVD is derived based on one or more temporal neighboring blocks and two spatial neighboring blocks of the current block, and said two spatial neighboring blocks are located at an above-right position and a left-bottom position of the current block.

The flowcharts shown above are intended to illustrate examples of a three-dimensional or multi-view video coding system using advanced temporal residual prediction or advanced residual prediction according to embodiments of the present invention. A person skilled in the art may modify each step, re-arranges the steps, split a step, or combine steps to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

The pseudo residual prediction and DV or MV estimation methods described above can be used in a video encoder as well as in a video decoder. Embodiments of pseudo residual prediction methods according to the present invention as described above may be implemented in various hardware, software codes, or a combination of both. For example, an embodiment of the present invention can be a circuit integrated into a video compression chip or program codes integrated into video compression software to perform the processing described herein. An embodiment of the present invention may also be program codes to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware codes may be developed in different programming languages and different format or style. The software code may also be compiled for different target platform. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method for three-dimensional or multi-view video coding, the method comprising:
receiving input data associated with a current block of a current picture in a current dependent view, wherein the current block is associated with one or more current motion or disparity parameters;
determining a corresponding block in a temporal reference picture in the current dependent view for the current block;
determining reference residual for the corresponding block according to said one or more current motion or disparity parameters; and
applying predictive encoding or decoding to the current block based on the reference residual.

2. The method of claim 1, wherein the corresponding block in the temporal reference picture is located based on the current block using a DMV (derived motion vector).

3. The method of claim 2, wherein the DMV corresponds to a selected MV (motion vector) of a selected reference block in a reference view.

4. The method of claim 3, wherein the selected reference block is located from the current block using a MV, a DV (disparity vector), or a DDV (derived DV) of the current block.

5. The method of claim 4, wherein the DDV is derived according to ADVD (adaptive disparity vector derivation), the ADVD is derived based on one or more temporal neighboring blocks and two spatial neighboring blocks, and said two spatial neighboring blocks are located at an above-right position and a left-bottom position of the current block.

6. The method of claim 5, said one or more temporal neighboring blocks correspond to one aligned temporal reference block and one collocated temporal reference block of the current block, and wherein the aligned temporal reference block is located in the temporal reference picture from the current block using a scaled MV.

7. The method of claim 5, wherein a default DV is used if any DV of said one or more temporal neighboring blocks and said two spatial neighboring blocks is not available.

8. The method of claim 3, wherein a default MV is used as the DMV when a picture order count of a reference picture of the selected reference block in the reference view is different from any picture order count of reference picture in each reference list of the current block, and wherein the default MV is a zero MV with reference picture index equal to 0.

9. The method of claim 2, wherein the DMV is scaled to a first temporal reference picture based on reference index of a reference list or a selected reference picture in the reference list, and wherein the first temporal reference picture or the selected reference picture is used as the temporal reference picture in the current dependent view for the current block.

10. The method of claim 2, wherein the DMV is set to one motion vector of a spatial neighboring block or a temporal neighboring block of the current block.

11. The method of claim 2, wherein the DMV is signaled explicitly in a bitstream.

12. The method of claim 1, wherein the corresponding block in the temporal reference picture corresponds to a collocated bock with a DMV (derived motion vector) equals to zero.

13. The method of claim 1, wherein the current block of the current picture in the current dependent view is coded using DCP (disparity compensated prediction) to form current residual of the current block.

14. The method of claim 13, wherein reference residual is used to predict the current residual of the current block.

15. The method of claim 1, wherein a flag is signaled for each block to control On, Off or weighting factor related to said predictive encoding or decoding of the current block based on the reference residual.

16. The method of claim 15, wherein the flag is explicitly signaled in a sequence level, view level, picture level or slice level.

17. The method of claim 15, wherein the flag is inherited in a Merge mode.

18. The method of claim 15, wherein the weighting factor corresponds to ½.

19. The method of claim 1, wherein the current block corresponds to a PU (prediction unit) or a CU (coding unit).

20. An apparatus for three-dimensional or multi-view video coding, the apparatus comprising one or more electronic circuits configured to:
receive input data associated with a current block of a current picture in a current dependent view, wherein the current block is associated with one or more current motion or disparity parameters;
determine a corresponding block in a temporal reference picture in the current dependent view for the current block;
determine reference residual for the corresponding block according to said one or more current motion or disparity parameters; and
apply predictive encoding or decoding to the current block based on the reference residual.

21. A method for three-dimensional or multi-view video coding, the method comprising:
receiving input data associated with a current block of a current picture in a current dependent view;
determining a corresponding block in an inter-view reference picture in a reference view for the current block using a DDV (derived DV) of the current block;
determining a first temporal reference block of the current block using a first motion vector of the current block;
determining a second temporal reference block of the corresponding block using the first motion vector;
determining reference residual for the corresponding block from the first temporal reference block and the second temporal block;
determining current residual from the current block and the corresponding block in the inter-view reference picture; and
applying predictive encoding or decoding to the current residual based on the reference residual; and
wherein the DDV is derived according to ADVD (adaptive disparity vector derivation), the ADVD is derived based on one or more temporal neighboring blocks and two spatial neighboring blocks of the current block, and said two spatial neighboring blocks are located at an above-right position and a left-bottom position of the current block.

22. The method of claim 14, wherein the reference residual is formed by performing disparity compensated prediction on the corresponding block in the temporal reference picture in the current dependent view by using a disparity vector of the current block.
